(19) United States
(12) Patent Application Publication
(10) Pub. No.: US 2018/0132126 A1
(43) Pub. Date: May 10, 2018

(54) INFORMATION PROCESSING SYSTEM, INFORMATION PROCESSING APPARATUS, AND INFORMATION PROCESSING PROGRAM MEDIUM

(71) Applicant: FUJITSU LIMITED, Kawasaki-shi (JP)

(72) Inventors: Hisatoshi YAMAOKA, Kawasaki (JP); Miwa Okabayashi, Sagamihara (JP)

(73) Assignee: FUJITSU LIMITED, Kawasaki-shi (JP)

(21) Appl. No.: 15/789,215

(22) Filed: Oct. 20, 2017

(30) Foreign Application Priority Data
Nov. 7, 2016 (JP) 2016-217567

(51) Int. Cl. H04W 28/02; H04L 29/08

(52) U.S. Cl. CPC H04W 28/0215; H04L 67/2842

(57) ABSTRACT

An information processing apparatus for connecting to a terminal via a first wireless communication medium and connecting to a network via a second wireless communication medium, the information processing apparatus including: a memory, and a processor coupled to the memory and configured to execute a process comprising; receiving data to the terminal from the network via the second wireless communication medium; caching the received data; selecting a node device to be a copy destination of the cached data out of the other node devices based on a prospect of the terminal to be reconnected to each of the other node devices and a communication load of the own node device for transmitting data to each of the other node devices; and transmitting the data to the selected node device via the first wireless communication medium.

### CROSS-REFERENCE TO RELATED APPLICATION

This application is based upon and claims the benefit of priority of the prior Japanese Patent Application No. 2016-217567, filed on Nov. 7, 2016, the entire contents of which are incorporated herein by reference.

### FIELD

The embodiments discussed herein are related to a cache technique in a communication node device.

### BACKGROUND

In order to increase the efficiency of a communication system, data to be transferred by a node device is sometimes cached by the node device. For example, when the same data is re-requested in a communication path including the node device, the communication is simplified by providing data that is cached by the node device.

However, not all communication paths that re-request the same data are the same as those at the time of making the previous requests. If a node device that has cached data is not included in a communication path that re-requests the data, the cached data is not used. If the cached data is scattered, the communication load increases.

Related-art techniques are disclosed in Japanese National Publication of International Patent Application No. 2016-506680, and International Publication Pamphlet No. WO 2012/144588.

According to an aspect of the present disclosure, it is desirable to reduce useless communication due to copying cache data.

### SUMMARY

According to an aspect of the invention, an information processing apparatus for connecting to a terminal via a first wireless communication medium and connecting to a network via a second wireless communication medium, the information processing apparatus includes: a memory, and a processor coupled to the memory and configured to execute a process comprising; receiving data to the terminal from the network via the second wireless communication medium; caching the received data; selecting a node device to be a copy destination of the cached data out of the other node devices based on a prospect of the terminal to be reconnected to each of the other node devices and a communication load of the own node device for transmitting data to each of the other node devices; and transmitting the data to the selected node device via the first wireless communication medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network configuration;

FIG. 2 is a diagram illustrating an overview of the present embodiment;

FIG. 3 is a diagram illustrating an overview of the present embodiment;

FIG. 4 is a diagram illustrating an example of a module configuration of an access point;

FIG. 5 is a diagram illustrating an example of an access point table;

FIG. 6 is a diagram illustrating an example of reconnection probabilities;

FIG. 7 is a diagram illustrating a sequence of calculation of a reconnection probability;

FIG. 8 is a diagram illustrating an example of a number of connections table;

FIG. 9 is a diagram illustrating an example of a connection relationship;

FIG. 10 is a sequence of calculation of the number of hops;

FIG. 11 is a diagram illustrating an example of a connection relationship table;

FIG. 12 is a diagram illustrating a sequence of copying cache data;

FIG. 13 is a flowchart of selection processing (A);

FIG. 14 is a diagram illustrating a sequence of using cache data;

FIG. 15 is a flowchart of selection processing (B);

FIG. 16 is a flowchart of selection processing (C); and

FIG. 17 is a functional block diagram of a computer.

### DESCRIPTION OF EMBODIMENTS

### First Embodiment

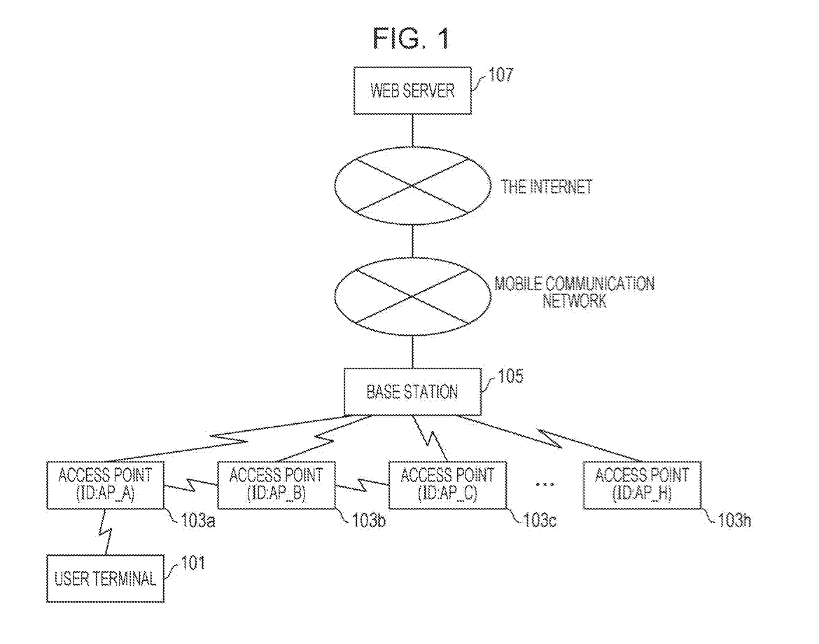

FIG. 1 illustrates an example of a configuration of a network. A user terminal 101 connects to a neighboring access point 103 via a wireless local area network (LAN). The access point 103 connects to a mobile communication network via a base station 105 using a wireless communication medium of a cellular system (for example, a third-generation mobile communication system, a fourth-generation mobile communication system, or a Long Term Evolution (LTE) system). Also, the mobile communication network is connected to the Internet. Accordingly, the user terminal 101 performs data transmission with a Web server 107 connected to the Internet via the above-described communication path. The user terminal 101 sends, for example, a request message to the Web server 107 and receives a response message returned from the Web server 107.

In this example, access points 103a to 103h are provided. The IDs of the access points 103a to 103h are AP_A to AP_H, respectively. The access points 103 in this example are mounted on automobiles, respectively. That is to say, the access points 103 are located at any place and may be moved at any time. The individual access points 103 exchange data with each other in the ad hoc mode of a wireless LAN. A part of the combinations out of the combinations of the access points 103 is not connected. For example, if one of the access points 103 has moved, and thus has been separated from the other access point 103, the mutual connection is sometimes broken. On the other hand, if one of the access points 103 has moved and comes close to the other of the access points 103, the mutual connection is sometimes established. For example, at the time of a large-scale disaster, vehicles of police forces, fire crews, emergency services, rescue teams, and the like gather in the vicinity of the disaster site. Each vehicle is provided with an access point function. User terminals, such as cell phones, tablet terminals, the other Web connection devices, and the like that are possessed by individual police officers, fire fighters, emergency persons, and the like perform communication by connecting to the access point of the nearest vehicle out of the various vehicles.

In this regard, the access points 103 in this system perform multi-hop communication. Each of the access points 103 operates so as to maintain shared data.

That is to say, an access point 103 in this system has a function of sharing data with the other access points 103 in the ad hoc mode in addition to the function of relaying data transmission between the user terminal 101 and the Web server 107.

In this regard, it is assumed that a user who holds the user terminal 101 moves. Accordingly, the user terminal 101 sometimes changes from a state of being connected to a certain access point 103 to a state of being connected to another access point 103.

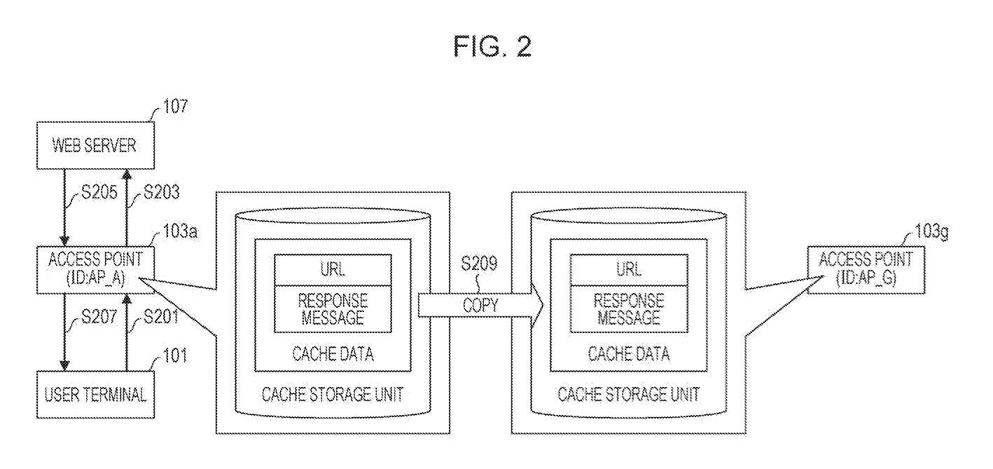

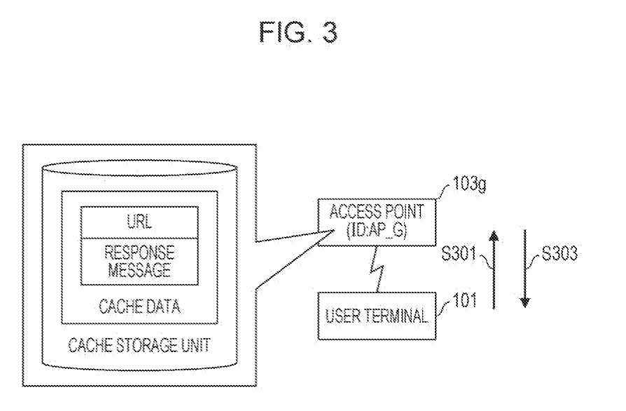

In the following, a description will be given of the overview of the present embodiment with reference to FIG. 2 and FIG. 3. The user terminal 101 connected to the access point 103a sends a request message addressed to the Web server 107 to the access point 103a via the wireless LAN (S201). The access point 103a transfers the received request message to the Internet via the mobile communication network. As a result, the request message reaches the Web server 107 (S203). The Web server 107 transmits a response message in accordance with the request message to the user terminal 101. The response message reaches the access point 103a via the Internet and the mobile communication network (S205). The access point 103a transfers the response message to the user terminal 101 via the wireless LAN (S207).

At this time, the access point 103a caches the response message. The cache data stored in the cache storage unit in this example includes the URL included in the request message and the response message. The cache storage unit is, for example, a key value store, and stores the URL and the response message in association with each other. A URL corresponds to a key, and a response message corresponds to a value. In this regard, a request message may be used as a key in place of a URL. In that case, cache data includes a request message and a response message.

In this manner, when the user terminal 101 connected to the access point 103a retransmits the request message addressed to the same URL, the cached response message is returned so that it is possible to reduce the communication load. Specifically, communications via the mobile communication network and the Internet are omitted.

In the present embodiment, further, in preparation for the case where the user terminal 101 connects to one of the access points 103 other than the access point 103a, the cache data is copied. For that purpose, the access point 103a selects one of the access points 103 that becomes a copy destination from the access point 103b to the access point 103h. The access point 103a then transmits the cache data to the selected access point 103 (S209).

In this example, it is assumed that the access point 103g was selected. The access point 103g that has received the cache data stores the received cache data in the own cache storage unit.

In this manner, as illustrated in FIG. 3, when the user terminal 101 connects to the access point 103g and sends a request message addressed to the same URL as that of the previous time (S301), the access point 103g reads a response message corresponding to the URL included in the request message from the cache storage unit, and returns the response message to the user terminal 101 (S303).

However, it becomes a problem of how to select an access point 103 of the copy destination. Even if an access point 103 (103a in the example described above) that cached has copied the cache data to an access point 103 (103g in the example described above) to be connected, there is no guarantee that the user terminal 101 moves in the vicinity of the access point 103 (103g) to which the cache data was copied. Unless the user terminal 101 moves in the vicinity of the access point 103 (103g), the transmission processing for copying becomes useless. Also, the area of the cache storage unit is wasted.

If an access point 103 to which the user terminal 101 next connects is identified, the user terminal 101 sometimes does not move in the vicinity of the access point 103. Accordingly, it is sometimes better to refrain from copying when the data transmission load to an access point 103 having a high expectancy of being connected next is high.

Thus in the present embodiment, a determination is made as to whether or not to select a candidate node device based on the load of the data transmission to the candidate node device and the prospect of the terminal reconnecting to the candidate node device. In the above, a description is completed of the overview in the present embodiment.

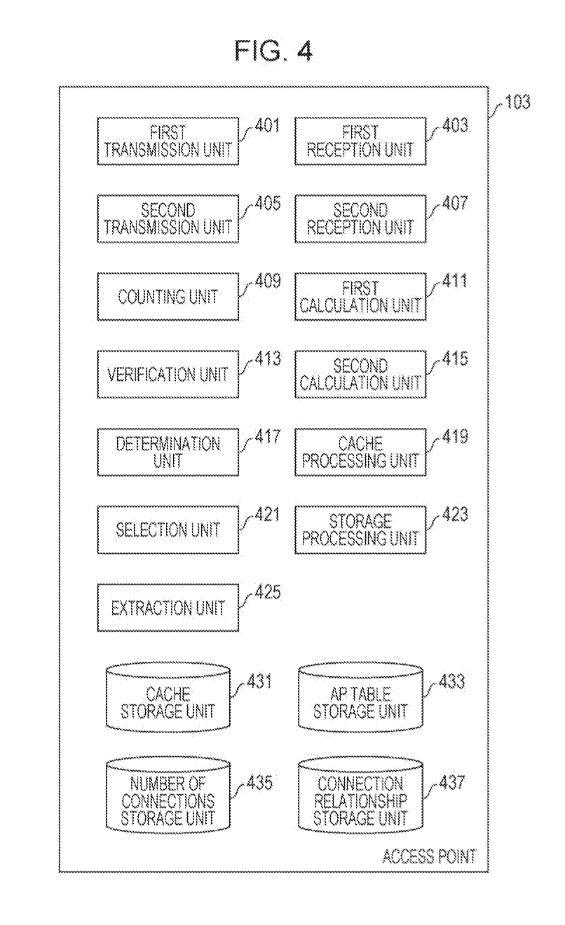

Next, a description will be given of the access point 103. FIG. 4 illustrates an example of the module configuration of the access point 103. The access point 103 includes a first transmission unit 401, a first reception unit 403, a second transmission unit 405, a second reception unit 407, a counting unit 409, a first calculation unit 411, a verification unit 413, a second calculation unit 415, a determination unit 417, a cache processing unit 419, a selection unit 421, a storage processing unit 423, an extraction unit 425, a cache storage unit 431, an access point (AP) table storage unit 433, a number of connections storage unit 435, and a connection relationship storage unit 437.

The first transmission unit 401 transmits various kinds of data via the wireless LAN. The first reception unit 403 receives various kinds of data via the wireless LAN. The second transmission unit 405 transmits various kinds of data via the mobile communication network. The second reception unit 407 receives various kinds of data via the mobile communication network. The counting unit 409 counts the number of times of connections between the other access points 103 and the user terminal 101 at the previous time. The first calculation unit 411 calculates the reconnection probabilities in the other access points 103. The verification unit 413 verifies whether or not a connection to the other access point 103 is possible. The second calculation unit 415 calculates the number of hops with the other access point 103. The determination unit 417 determines whether or not a response message corresponding to the URL included in a request message is cached. The cache processing unit 419 caches a response message. The selection unit 421 selects an access point 103 to be a copy destination. The storage processing unit 423 performs the processing for storing the cache data in the cache storage unit 431. The extraction unit 425 extracts a response message corresponding to the URL from the cache storage unit 431.

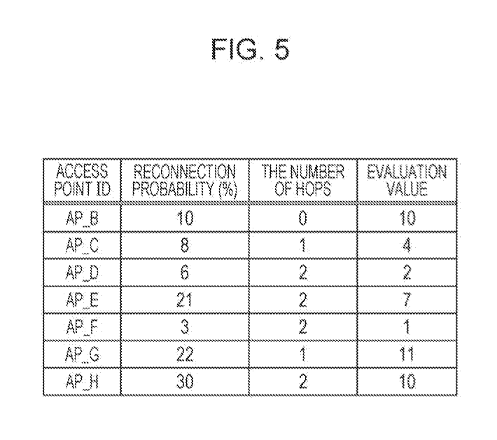

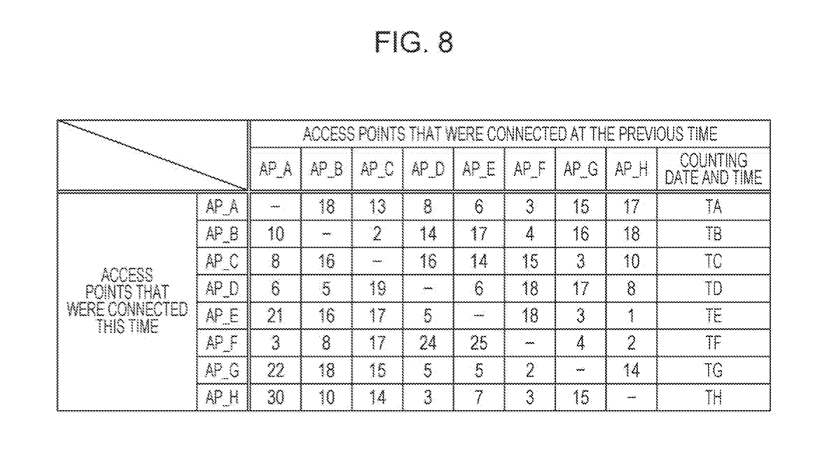

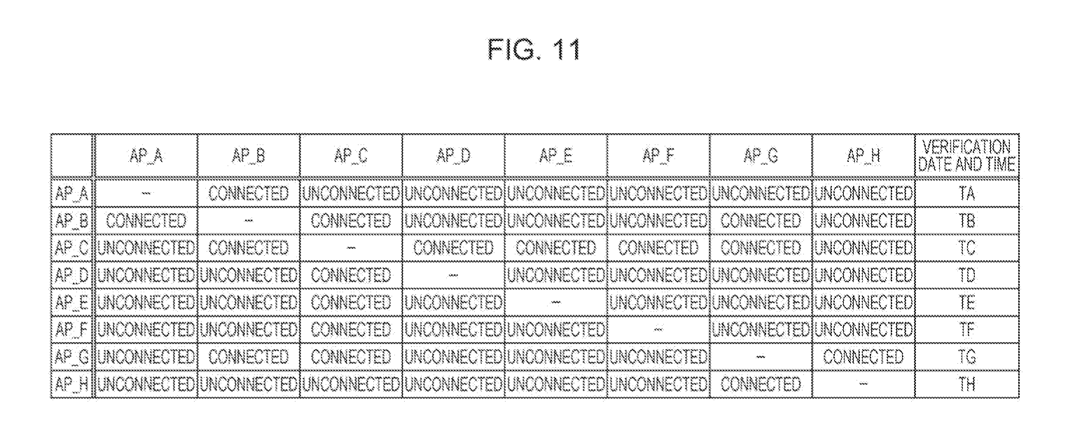

The cache storage unit 431 stores cache data. The AP table storage unit 433 stores the access point tables. A description will be given later of the access point table with reference to FIG. 5. The number of connections storage unit 435 stores the number of connections table. A description will be given later of the number of connections table with reference to FIG. 8. The connection relationship storage unit 437 stores the connection relationship table. A description will be given later of the connection relationship table with reference to FIG. 11.

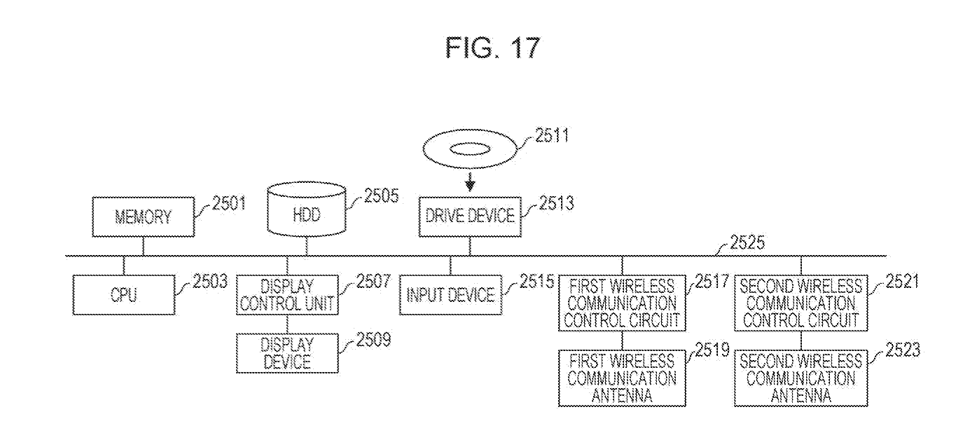

The above-described first transmission unit 401, first reception unit 403, second transmission unit 405, second reception unit 407, counting unit 409, first calculation unit 411, verification unit 413, second calculation unit 415, determination unit 417, cache processing unit 419, selection unit 421, storage processing unit 423, and extraction unit 425 are realized by using hardware resources (for example, FIG. 17) and programs that cause a processor to perform the processing described below.

The above-described cache storage unit 431, AP table storage unit 433, the number of connections storage unit 435, and connection relationship storage unit 437 are realized by using hardware resources (for example, FIG. 17).

FIG. 5 illustrates an example of the access point table. The access point table in this example includes records corresponding to the access points 103 (hereinafter referred to as the other access points 103) other than the own access point 103 holding the access point table. A record of the access point table includes a field in which an access point ID is set, a field in which a reconnection probability is stored, a field in which the number of hops is stored, and a field in which an evaluation value is stored. It is assumed that access point IDs are set in advance. FIG. 5 is the access point table held by the access point 103a having an ID:AP_A.

A reconnection probability is a probability that the user terminal 101 reconnects to a specific access point 103. The number of hops is the number of access points 103 that perform relaying in the shortest communication path with a specific access point 103. An evaluation value indicates the suitability for a copy destination of the cache data. The evaluation value in this example is the quotient when the reconnection probability is divided by (the number of hops+1). Accordingly, an access point 103 having a high reconnection probability has a high evaluation value. That is to say, a reconnection probability and an evaluation value have a positive correlation. Also, an access point 103 having a high number of hops has a low evaluation value. That is to say, the number of hops and an evaluation value has a negative correlation.

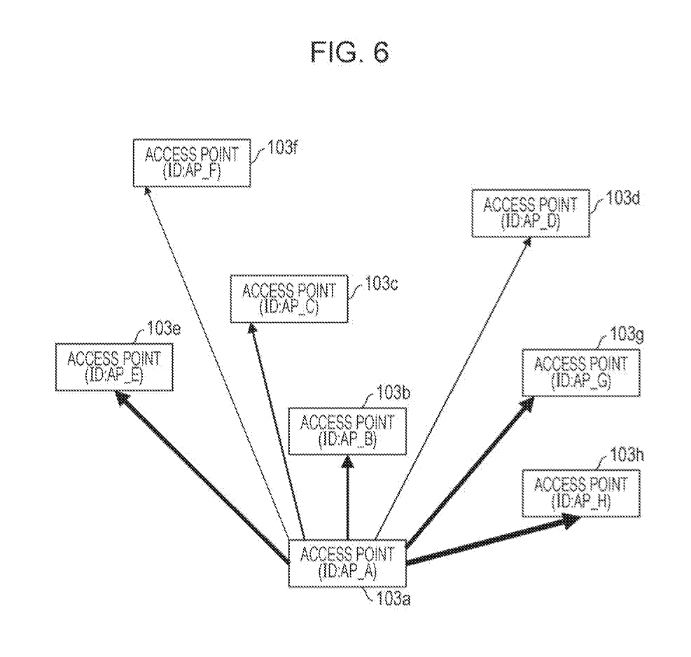

In the following, a description will be given of an example of a reconnection probability and the calculation processing of reconnection probability. In the example in FIG. 5, the user terminal 101 connected to the access point 103a has a probability of reconnecting next to the access point 103b having an ID:AP_B is 10 percent. In the same manner, the user terminal 101 connected to the access point 103a has a probability of reconnecting next to the access point 103c having an ID:AP_C is 8 percent. In the same manner, the user terminal 101 connected to the access point 103a has a probability of reconnecting next to the access point 103d having an ID:AP_D is 6 percent. In the same manner, the user terminal 101 connected to the access point 103a has a probability of reconnecting next to the access point 103e having an ID:AP_E is 21 percent. In the same manner, the user terminal 101 connected to the access point 103a has a probability of reconnecting next to the access point 103f having an ID:AP_F is 3 percent. In the same manner, the user terminal 101 connected to the access point 103a has a probability of reconnecting next to the access point 103g having an ID:AP_G is 22 percent. In the same manner, the user terminal 101 connected to the access point 103a has a probability of reconnecting next to the access point 103h having an ID:AP_H is 30 percent. FIG. 6 illustrates an example of reconnection probabilities. The width of an arrow line indicates a magnitude of the reconnection probability.

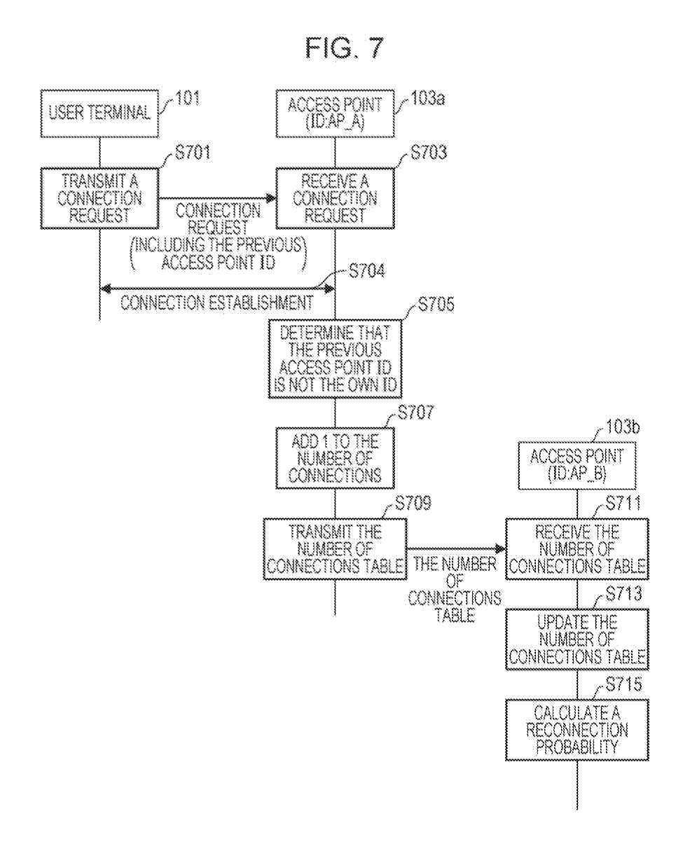

A description will be given of the processing for calculating a reconnection probability with reference to the sequence illustrated in FIG. 7. The user terminal 101 transmits a connection request to the access point 103a (S701). The connection request includes an ID (hereinafter referred to as the previous access point ID) of the access point 103 to which the user terminal 101 connected at the previous time.

The first reception unit 403 of the access point 103a receives a connection request (S703). When the connection is established (S704), the counting unit 409 of the access point 103a determines whether or not the previous access point ID included in the received connection request is the own ID of the access point 103a. If the previous access point ID is the own ID of the access point 103a, the processing illustrated in S707 and after that is not performed.

In this sequence, it is assumed that the previous access point ID is not the own ID of the access point 103a (S705). If the previous access point ID is not the own ID of the access point 103a, the number of connections table is updated. In this regard, when there are a plurality of user terminals 101, the individual user terminals do not have to be distinguished. For any user terminal, an access point to which the terminal is connected at the previous time and an access point to which the terminal is to be connected this time ought to be identified.

FIG. 8 illustrates an example of the number of connections table. The number of connections table in this example includes a record corresponding to the access point 103 that counts. The record in the number of connections table has a field in which the number of times of connections with the individual other access points 103 is stored and a field in which the counting date and time is stored.

The first record illustrated in FIG. 8 is a count result by the access point 103a having the ID:AP_A. This record illustrates that the number of cases in which the user terminal 101 connected to the access point 103a had previously connected to the access point 103b having the ID:AP_B is “18”. This record illustrates that the number of cases in which the user terminal 101 connected to the access point 103a had previously connected to the access point 103c having the ID:AP_C is “13”. This record illustrates that the number of cases in which the user terminal 101 connected to the access point 103a had previously connected to the access point 103d having the ID:AP_D is “8”. This record illustrates that the number of cases in which the user terminal 101 connected to the access point 103a had previously connected to the access point 103e having the ID:AP_E is “6”. This record illustrates that the number of cases in which the user terminal 101 connected to the access point 103a had previously connected to the access point 103f having the ID:AP_F is “3”. This record illustrates that the number of cases in which the user terminal 101 connected to the access point 103a had previously connected to the access point 103g having the ID:AP_G is “15”. This record illustrates that the number of cases in which the user terminal 101 connected to the access point 103a had previously connected to the access point 103h having the ID:AP_H is “17”.

Also, the number of connection times “10” of AP_A in the second record illustrates that there are 10 cases in which the user terminal 101 that had connected to the access point 103a having the ID:AP_A next connected to the access point 103b having the ID:AP_B. The number of connection times “8” of AP_A in the third record illustrates that there are 8 cases in which the user terminal 101 that had connected to the access point 103a having the ID:AP_A next connected to the access point 103c having the ID:AP_C. The number of connection times “6” of AP_A in the fourth record illustrates that there are 6 cases in which the user terminal 101 that had connected to the access point 103a having the ID:AP_A next connected to the access point 103d having the ID:AP_D. The number of connection times “21” of AP_A in the fifth record illustrates that there are 21 cases in which the user terminal 101 that had connected to the access point 103a having the ID:AP_A next connected to the access point 103e having the ID:AP_E. The number of connection times “3” of AP_A in the sixth record illustrates that there are 3 cases in which the user terminal 101 that had connected to the access point 103a having the ID:AP_A next connected to the access point 103f having the ID:AP_F. The number of connection times “22” of AP_A in the seventh record illustrates that there are 22 cases in which the user terminal 101 that had connected to the access point 103a having the ID:AP_A next connected to the access point 103g having the ID:AP_G. The number of connection times “30” of AP_A in the sixth record illustrates that there are 30 cases in which the user terminal 101 that had connected to the access point 103a having the ID:AP_A next connected to the access point 103h having the ID:AP_H. Based on these numbers of connection times, the probability of reconnection of the access point 103 next of the access point 103a having the ID:AP_A, that is to say, the reconnection probabilities are obtained.

Referring back to FIG. 7, if the previous access point ID is not the ID of the own access point 103a, the counting unit 409 of the access point 103a adds 1 to the number of connection times corresponding to the previous access point ID in the record (the first record in FIG. 8) of the own access point 103a in the number of connections table (S707). At this time, the counting date and time in the record is rewritten by the current date and the current time.

The first transmission unit 401 of the access point 103a transmits the updated number of connections table to another access point 103 (S709). In this example, the access point 103a transmits the number of connections table to the access point 103b.

When the first reception unit 403 of the access point 103b receives the number of connections table (S711), the first calculation unit 411 of the access point 103b updates the number of connections table held by itself (S713). Specifically, the first calculation unit 411 of the access point 103b determines whether or not the counting date and time in the received number of connections table is newer than the counting date and time in the number of connections table held by itself for each record. If determined the counting date and time of the received number of connections table is newer, the first calculation unit 411 rewrites the record of the number of connections table held by itself such that the record becomes identical to the record in the received number of connections table. If determined that the counting date and time in the received number of connections table is older, or the both are equal, the first calculation unit 411 does not update the record in the number of connections table held by itself.

The first calculation unit 411 of the access point 103b calculates the reconnection probability based on the updated number of connections table (S715). Specifically, the first calculation unit 411 of the access point 103b reads the number of connection times of AP_B in the records other than the second record of the access point 103b itself, that is to say, the first record and the third record to the eighth record, and obtains the total of those. That is to say, the total number of times of connection to the other access points 103 after the connection to the access point 103b is calculated. By dividing the number of connection times of AP_B in the first record, and the third record to the eighth record by the total, the reconnection probabilities in AP_A, AP_C to AP_H are obtained. The reconnection probabilities are stored in the access point table.

By performing the same processing as the processing in this sequence for each pair of the access points 103 that connects to each other via the wireless LAN, the same number of connections table will be held by each access point 103. Also, the reconnection probabilities are calculated for each access point 103.

Next, a description will be given of an example of the number of hops. As described above, the number of hops is the number of the other access points 103 that perform relaying in the shortest communication path connecting two access points 103. Accordingly, the number of hops is determined by a connection relationship of each access point 103. In this regard, when two access points 103 directly connect to each other, the number of hops is 0.

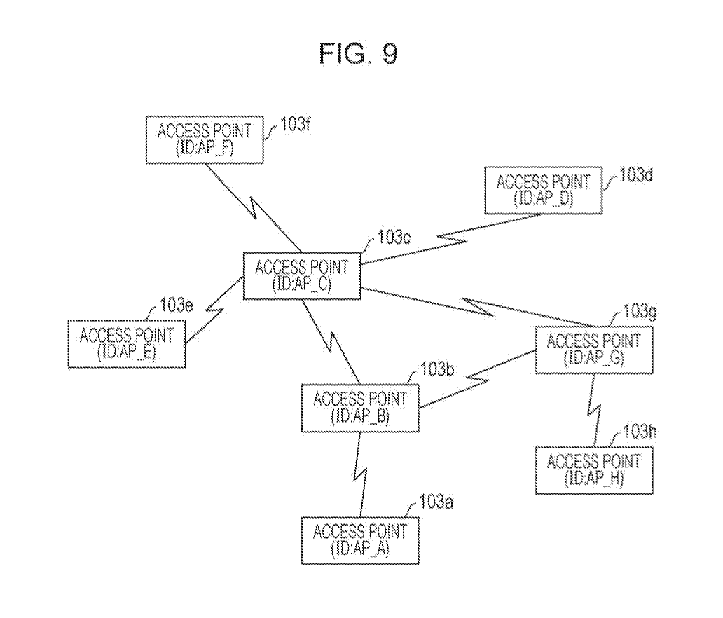

FIG. 9 illustrates an example of a connection relationship. In this example, two access points 103 that are connected to each other are linked by a line. Two access points 103 that are not linked to each other by a line fail in connection.

For example, there are no relaying access points 103 in the communication path that connects the access point 103a and the access point 103b, and thus the number of hops regarding a pair of the access point 103a and the access point 103b is 0. In the same manner, the access point 103b performs relaying in the shortest communication path that connects the access point 103a and the access point 103c, and thus the number of hops regarding a pair of the access point 103a and the access point 103c is 1. In the same manner, the access point 103b and the access point 103c perform relaying in the shortest communication path that connects the access point 103a and the access point 103d, the number of hops regarding a pair of the access point 103a and the access point 103d is 2.

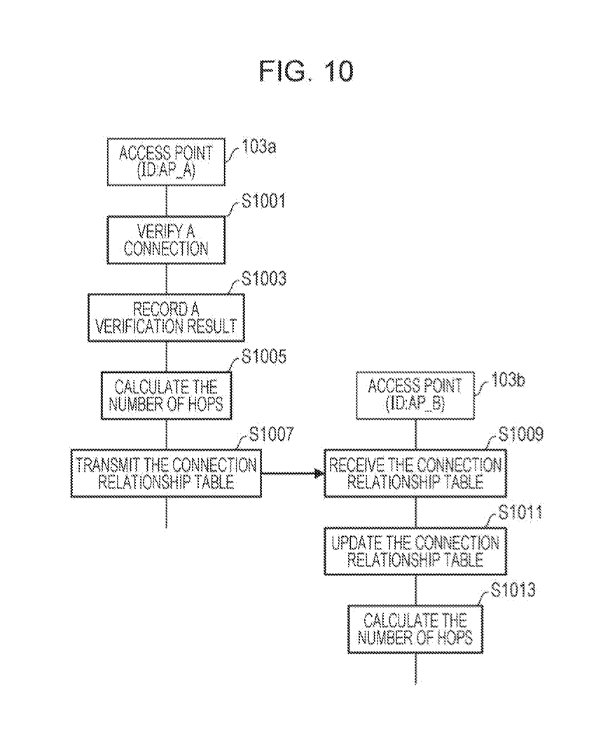

Next, a description will be given of the processing for calculating the number of hops with reference to the sequence illustrated in FIG. 10. The verification unit 413 of the access point 103a periodically performs connection verification (S1001). Specifically, the verification unit 413 of the access point 103a attempts to connect to each access point 103 other than the access point 103a and determines whether or not the connection to each access point 103 succeeds or fails.

The verification unit 413 of the access point 103a records the verification result in the connection relationship table (S1003).

FIG. 11 illustrates an example of the connection relationship table. The connection relationship table in this example has a record corresponding to the access point 103 that performs connection verification. A record in the connection relationship table has a field in which a relationship with each of the access points 103, which is a verification target, that is to say, the individual other access points 103, and a field in which verification date and time is stored.

The relationship with the access point 103 is “connected” or “unconnected”. As a result of the access point 103 that performs connection verification having attempted to connect with the access point 103 of the verification target, if the connection succeeds, the relationship between them is “connected”. On the other hand, as a result of the access point 103 that performs connection verification having attempted to connect with the access point 103 of the verification target, if the connection fails, the relationship between them is “unconnected”. The verification date and time is a date and time when the connection verification was performed.

The first record illustrated in FIG. 11 corresponds to a verification result of the access point 103a having the ID:AP_A. Specifically, the second field, “connected”, illustrates that a result of an attempt to connect to the access point 103b having the ID:AP_B was a success. The third field, “unconnected”, illustrates that a result of an attempt to connect to the access point 103c having the ID:AP_C was a failure. The fourth field, “unconnected”, illustrates that a result of an attempt to connect to the access point 103d having the ID:AP_D was a failure. The fifth field, “unconnected”, illustrates that a result of an attempt to connect to the access point 103e having the ID:AP_E was a failure. The sixth field, “unconnected”, illustrates that a result of an attempt to connect to the access point 103f having the ID:AP_F was a failure. The seventh field, “unconnected”, illustrates that a result of an attempt to connect to the access point 103g having the ID:AP_G was a failure. The eighth field, “unconnected”, illustrates that a result of an attempt to connect to the access point 103h having the ID:AP_H was a failure.

Referring back to FIG. 10, the second calculation unit 415 of the access point 103a calculates the number of hops concerning each pair of the access point 103a and the other access points 103 (S1005). Specifically, the second calculation unit 415 of the access point 103a identifies each communication path connecting the two access points 103, and calculates the number of access points 103 that perform relaying in each communication path, that is to say, the number of hops. The second calculation unit 415 of the access point 103a identifies the minimum value out of the calculated numbers of hops. The number of hops is stored in the access point table.

The first transmission unit 401 of the access point 103a transmits the connection relationship table to the other access point 103 (S1007). In this example, the access point 103a sends the number of connections table to the access point 103b.

When the first reception unit 403 of the access point 103b receives a connection relationship table (S1009), the second calculation unit 415 of the access point 103b updates the connection relationship table held by itself (S1011). Specifically, the second calculation unit 415 of the access point 103b determines whether or not the verification date and time in the received connection relationship table is newer than the verification date and time in the connection relationship table held by itself for each record. If determined that the verification date and time in the received connection relationship table is newer, the second calculation unit 415 rewrites the record in the connection relationship table held by itself so as to make the record identical to the record in the received connection relationship table. If determined that the verification date and time in the received connection relationship table is older, or both of them are equal, the second calculation unit 415 does not update the record in the connection relationship table held by itself.

The second calculation unit 415 of the access point 103b calculates the number of hops based on the updated connection relationship table (S1013). The number of hops is stored in the access point table.

When the same processing as the processing in this sequence is performed for each pair of the access points 103 that connect with each other via the wireless LAN, the same connection relationship table will be held by each access point 103. Also, the number of hops will be calculated by each access point 103. Now, a description will be completed of the number of hops.

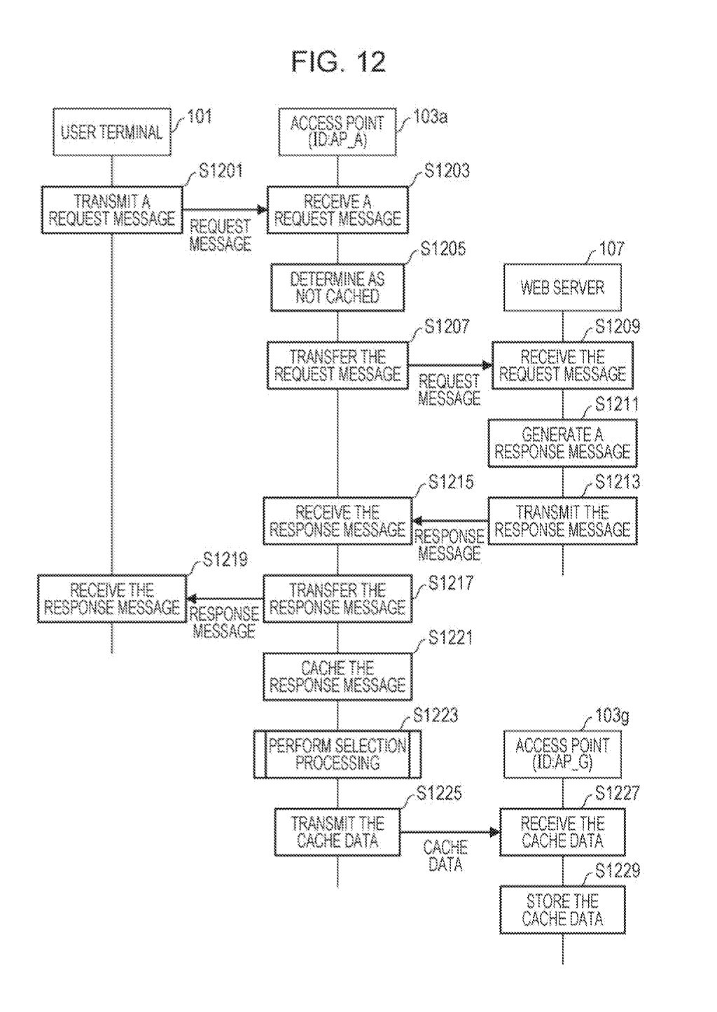

Next, a description will be given of the copy processing of cache data with reference to the sequence illustrated in FIG. 12. The user terminal 101 transmits a request message including the URL of the Web server 107 to the access point 103a via the wireless LAN (S1201).

When the first reception unit 403 of the access point 103a receives a request message (S1203), the determination unit 417 of the access point 103a determines whether or not a response message corresponding to the URL included in the request message is cached.

If determined that a response message corresponding to the URL included in the request message is not cached (S1205), the second transmission unit 405 of the access point 103a transfers the request message to the Web server 107 (S1207).

When the Web server 107 receives a request message (S1209), the Web server 107 generates a response message in accordance with the request message (S1211). The Web server 107 then transmits the generated response message to the user terminal 101 (S1213).

When the second reception unit 407 of the access point 103a receives a response message (S1215), the first transmission unit 401 of the access point 103a transfers the response message to the user terminal 101 via the wireless LAN (S1217). The user terminal 101 then receives the response message (S1219).

The cache processing unit 419 of the access point 103a caches the response message (S1221). Specifically, the cache processing unit 419 of the access point 103a stores the URL included in the request message and the response message in the cache storage unit 431 in association with each other. For example, both of them are stored in a key value store using a URL as a key and a response message as a value.

The selection unit 421 of the access point 103a performs selection processing (S1223). In the selection processing, the selection unit 421 selects an access point 103 to be a copy destination of the cache data.

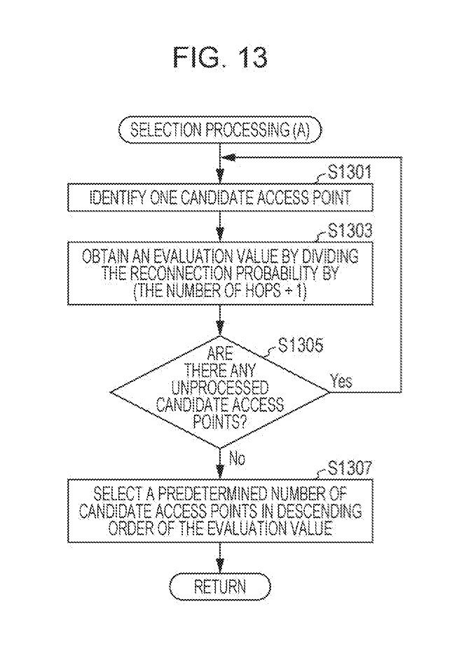

In the present embodiment, selection processing (A) is performed. FIG. 13 illustrates the selection processing (A) flow. The selection unit 421 of the access point 103a identifies one access point 103 other than the access point 103a, that is to say, a candidate access point (S1301).

The selection unit 421 of the access point 103a obtains an evaluation value by dividing the reconnection probability of the candidate access point by (the number of hops of the candidate access point+1) (S1303).

The selection unit 421 of the access point 103a determines whether or not there are unprocessed candidate access points (S1305). If determined that there is an unprocessed candidate access point, the processing returns of the processing illustrated in S1301, and the above-described processing is repeated.

On the other hand, if determined that there are no unprocessed candidate access points, the selection unit 421 of the access point 103a selects a predetermined number of candidate access points in descending order to the evaluation value (S1307). The predetermined number of is 1, for example. The predetermined number may be 2 or more. If the predetermined number is 1, an access point 103g having ID:AP_G is selected in the example in FIG. 5.

Referring back to FIG. 12, in this example, it is assumed that the access point 103g is selected as a copy destination in the selection processing (A). The first transmission unit 401 of the access point 103a transmits the cache data to the selected access point 103g (S1225).

When the first reception unit 403 of the access point 103g receives the cache data (S1227), the storage processing unit 423 of the access point 103g stores the received cache data in the cache storage unit 431 (S1229).

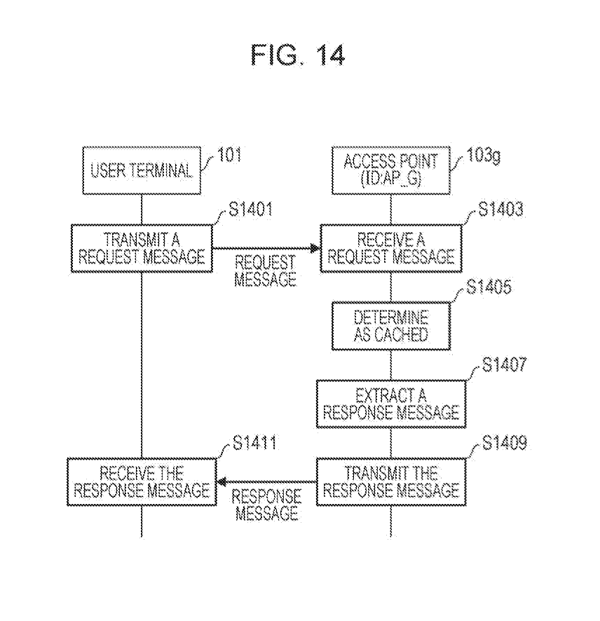

Next, a description will be given of the processing in the case of using cache data with reference to the sequence illustrated in FIG. 14. The user terminal 101 transmits a request message including the URL of the Web server 107 to the access point 103g via the wireless LAN (S1401).

When the first reception unit 403 of the access point 103g receives a request message (S1403), the determination unit 417 of the access point 103g determines whether or not a response message corresponding to the URL included in the request message is cached.

If determined that a response message corresponding to the URL included in the request message is cached (S1405), the extraction unit 425 of the access point 103g extracts a response message corresponding to the URL from the cache storage unit 431 (S1407). The first transmission unit 401 of the access point 103g transmits the response message to the user terminal 101 via the wireless LAN (S1409). The user terminal 101 then receives the response message (S1411).

With the present embodiment, it is possible to reduce useless communication due to copying of cache data. In this regard, with the present embodiment, it becomes indispensable to perform communication in order to exchange various tables among the access points. However, the amount of the communication data is an insignificant amount compared with the amount of data to be cached.

Also, when a connection relationship among the access points 103 changes, it is possible to suitably select a copy destination.

Also, the reconnection probability is calculated based on the result, and thus the precision of the reconnection probability is increased.

Also, with the selection processing (A), it is possible to select a more suitable copy destination.

### Second Embodiment

In the present embodiment, a description will be given of an example in which an access point 103 having an evaluation value equal to or higher than a reference is selected.

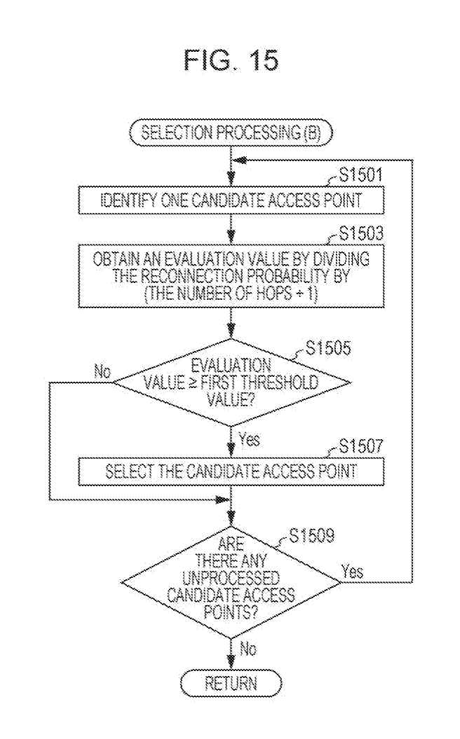

In the present embodiment, selection processing (B) is performed in place of the selection processing (A). FIG. 15 illustrates a selection processing (B) flow. The selection unit 421 of the access point 103a identifies one access point 103 other than the access point 103a, that is to say, a candidate access point (S1501).

The selection unit 421 of the access point 103a obtains an evaluation value by dividing the reconnection probability of the candidate access point by (the number of hops of the candidate access point+1) (S1503).

The selection unit 421 of the access point 103a determines whether or not the evaluation value is equal to or higher than a first threshold value (S1505). If determined that the evaluation value is equal to or higher than the first threshold value, the selection unit 421 of the access point 103a selects the candidate access point (S1507). On the other hand, if determined that the evaluation value is lower than the first threshold value, the processing proceeds to the processing in S1509 without change.

The selection unit 421 of the access point 103a determines whether or not there is an unprocessed candidate access point (S1509). If determined that there is an unprocessed candidate access point, the processing returns to the processing illustrated in S1501, and the above-described processing is repeated. On the other hand, if determined that there are no unprocessed candidate access points, the selection processing (B) is terminated.

With the present embodiment, it is easy to standardize selection of a copy destination.

### Third Embodiment

In the present embodiment, a description will be given of an example of selecting an access point 103 having a reconnection probability equal to or higher than the reference and the number of hops less than or equal to the reference.

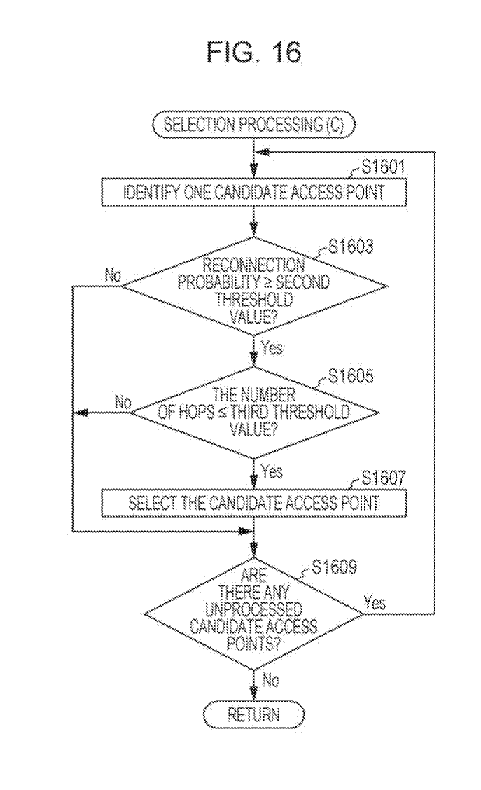

In the present embodiment, selection processing (C) is performed in place of the selection processing (A). FIG. 16 illustrates a selection processing (C) flow. The selection unit 421 of the access point 103a identifies one access point 103 other than the access point 103a, that is to say, a candidate access point (S1601).

The selection unit 421 of the access point 103a determines whether or not the reconnection probability of the candidate access point is equal to or higher than the second threshold value (S1603). If determined that the reconnection probability of the candidate access point is less than the second threshold value, the processing proceeds to the processing in S1609 without change.

On the other hand, if determined that the reconnection probability of the candidate access point is equal to or higher than the second threshold value, the selection unit 421 of the access point 103a determines whether or not the number of hops of the candidate access point is less than or equal to the third threshold value (S1605). If determined that the number of hops of the candidate access point is higher than a third threshold value, the processing proceeds to the processing in S1609 without change.

On the other hand, if the number of hops of the candidate access point is less than or equal to a third threshold value, the selection unit 421 of the access point 103a selects the candidate access point (S1607).

The selection unit 421 of the access point 103a determines whether or not there are unprocessed candidate access points (S1609). If determined that there is an unprocessed candidate access point, the processing returns to the processing in S1601, and the above-described processing is repeated. On the other hand, if determined that there are no unprocessed candidate access points, the selection processing (C) is terminated.

With the present embodiment, it is possible to diversify the reference in the selection of a copy destination.

In this regard, the above-described reconnection probability is an example of a prospect of reconnecting to the other access point 103. The prospect of reconnecting to the other access point 103 is not limited to the above-described reconnection probability.

The prospect of reconnecting to the other access point 103 may be calculated based on a direct distance between two access points 103 or a moving distance. For example, the reciprocal of the direct distance or the moving distance may be the prospect. The access point 103 may obtain location information of the other access point 103 and perform calculation processing of the prospect. Alternatively, a device disposed on the Internet may collect location information of each access point 103 and may perform the processing for calculating the prospect.

Also, the prospect of reconnecting to the other access point 103 may be calculated based on the direct distance between the user terminal 101 and the access point 103 or the moving distance. For example, the reciprocal of the direct distance or the moving distance may be the prospect. The access point 103 may obtain the location information of the user terminal 101 and the location information of the access point 103 and may perform the calculation processing. Alternatively, a device disposed on the Internet may collect the location information of the user terminal 101 and the location information of each access point 103 and may perform the calculation processing.

The number of hops is an example of the communication load accompanied by multi-hop communication. The communication load is not limited to the number of hops. The communication load may be, for example, a predetermined time period for transmitting a predetermined size of data or the rate of the occurrence of error.

In the above, descriptions have been given of the embodiments of the present disclosure. However, the present disclosure is not limited to these. For example, the above-described functional block configuration sometimes does not match the program module configuration.

Also, the structure of each storage area described above is an example, and does not have to be the structure as described above. Further, in the processing flow, as long as the processing result does not change, the order to the processing may be replaced or a plurality of processes may be executed in parallel.

In this regard, the access point 103 described above is a computer device, and as illustrated in FIG. 17, includes a memory 2501, a central processing unit (CPU) 2503, a hard disk drive (HDD) 2505, a display control unit 2507 connected to a display device 2509, a drive device 2513 for a removable disk 2511, an input device 2515, a first wireless communication control circuit 2517, and a second wireless communication control circuit 2521 that are connected via a bus 2525.

The first wireless communication control circuit 2517 is connected to the first wireless communication antenna 2519. The first wireless communication antenna 2519 transmits and receives radio waves via the wireless LAN system. The first wireless communication control circuit 2517 performs control to the wireless communication in accordance with the use frequency of the wireless LAN system. The second wireless communication control circuit 2521 is connected to the second wireless communication antenna 2523. The second wireless communication antenna 2523 transmits and receives radio waves by a cellular system. The second wireless communication control circuit 2521 performs control of the wireless communication in accordance with the use frequency in the cellular system.

The operating system (OS) and the application programs for performing the processing in the embodiments are stored in the HDD 2505, and are read by the CPU 2503 from the HDD 2505 to the memory 2501 at the time of being executed. The CPU 2503 controls the display control unit 2507, the first wireless communication control circuit 2517, the second wireless communication control circuit 2521, and the drive device 2513 in accordance with the processing contents of the application programs. Also, the intermediate processing data is mainly stored in the memory 2501, but may also be stored in the HDD 2505. In the embodiments of the present disclosure, the application programs for performing the above-described processing are stored in a computer-readable removable disk 2511, and distributed and installed from the drive device 2513 in the HDD 2505. For example, the application programs are sometimes installed in the HDD 2505 via the Internet, the mobile communication network, and the second wireless communication control circuit 2521. In such a computer device, hardware, such as the above-described CPU 2503, memory 2501, or the like, and the programs, such as the OS and the application programs, and the like organically cooperate so as to realize the various functions as described above.

The embodiments of the present disclosure, described above, are summarized as follows.

An information processing system according to the present embodiment includes a plurality of node devices for connecting to a terminal via a first wireless communication medium and connecting to a network via a second wireless communication medium. Each of the plurality of node devices includes (A) a reception unit that receives data to the terminal via the second wireless communication medium, (B) a cache processing unit that caches the data, (C) a selection unit that selects a node device to be a copy destination of the cached data out of the other node devices based on a prospect of the terminal reconnecting each of the other node devices and a communication load of when the node device itself performs data transmission to each of the other node devices, and (D) a transmission unit that transmits the data to the selected node device via the first wireless communication medium.

In this manner, it is possible to reduce useless communication due to copying of the cache data.

The plurality of node devices may perform multi-hop communication. Further, the above-described communication load may be a load accompanied by multi-hop communication.

In this manner, when a connection relationship of a node device changes, it is possible to suitably select a copy destination.

The above-described prospect may be a reconnection probability that is calculated based on the result of the reconnection to the other node devices after the connection to the node device itself.

In this manner, the precision of the prospect of reconnection is increased.

The selection unit may calculate an index having a positive correlation with the prospect and a negative correlation with the communication load, and may select the other node device having a higher index with priority.

In this manner, it is possible to select a more suitable copy destination.

The selection unit may calculate an index having a positive correlation with the prospect and a negative correlation with the communication load, and may select the other node device having an index equal to or higher than the reference.

In this manner, it is easy to standardize the selection of a copy destination.

The selection unit may select the other node device having the prospect equal to or higher than the first reference and the communication load lees than or equal to the second reference.

In this manner, it is possible to diversify the reference in the selection of a copy destination.

In this regard, it is possible to create a program for causing a computer to perform the processing of the above-described node device. The program may be stored in a computer-readable storage medium or a storage device, for example, a flexible disk, a CD-ROM, a magneto-optical disk, a semiconductor memory, a hard disk, or the like. In this regard, in general, the intermediate processing result is temporarily stored in a storage device, such as a main memory, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system including a plurality of node devices connected to a terminal via a first wireless communication medium and connected to a network via a second wireless communication medium, each of the plurality of node devices comprising:
a memory, and
a processor coupled to the memory and configured to execute a process comprising;
receiving data to the terminal from the network via the second wireless communication medium;
caching the received data;
selecting a node device to be a copy destination of the cached data out of the other node devices based on a prospect of the terminal to be reconnected to each of the other node devices and a communication load of the own node device for transmitting data to each of the other node devices; and
transmitting the data to the selected node device via the first wireless communication medium.

2. The information processing system according to claim 1,
wherein the plurality of node devices perform multi-hop communication, and
the communication load is a load accompanied by the multi-hop communication.

3. The information processing system according to claim 1,
wherein the prospect is a reconnection probability calculated based on a result of reconnection of the terminal to the other node devices after connection to the own node device.

4. The information processing system according to claim 1,
wherein in the selecting, an index having a positive correlation with the prospect and having a negative correlation with the communication load is calculated for each of the other node devices, and the other node device having the higher index is selected with higher priority.

5. The information processing system according to claim 1,
wherein in the selecting, an index having a positive correlation with the prospect and having a negative correlation with the communication load is calculated for each of the other node devices, and the other node device having the index higher than a predetermined reference is selected.

6. The information processing system according to claim 1,
wherein in the selecting, the other node device having the prospect higher than a first predetermined reference and the communication load lower than a second predetermined reference is selected.

7. An information processing apparatus for connecting to a terminal via a first wireless communication medium and connecting to a network via a second wireless communication medium, the information processing apparatus comprising:
a memory, and
a processor coupled to the memory and configured to execute a process comprising;
receiving data to the terminal from the network via the second wireless communication medium;
caching the received data;
selecting a node device to be a copy destination of the cached data out of the other node devices based on a prospect of the terminal to be reconnected to each of the other node devices and a communication load of the own node device for transmitting data to each of the other node devices; and
transmitting the data to the selected node device via the first wireless communication medium.

8. A computer-readable and non-transitory medium storing an information processing program that causes an information processing apparatus for connecting to a terminal via a first wireless communication medium and connecting to a network via a second wireless communication medium to perform a process comprising:
receiving data to the terminal from the network via the second wireless communication medium;
caching the received data;
selecting a node device to be a copy destination of the cached data out of the other node devices based on a prospect of the terminal to be reconnected to each of the other node devices and a communication load of the own node device for transmitting data to each of the other node devices; and
transmitting the data to the selected node device via the first wireless communication medium.
